(19) United States
(12) Patent Application Publication
(10) Pub. No.: US 2005/0275892 A1
(43) Pub. Date: Dec. 15, 2005

(54) Method and apparatus for inputting and outputting image data, computer program for executing the method, and recording medium for the computer program

(76) Inventors: Yuriko Obata, Tokyo (JP); Hiromitsu Shimizu, Yokohama city (JP); Norio Michiie, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/151,409

(22) Filed: Jun. 14, 2005

(30) Foreign Application Priority Data
Jun. 14, 2004 (JP) 2004-175801

(51) Int. Cl. G06F 15/00

(52) U.S. Cl. 358/1.16

(57) ABSTRACT

An image input and output apparatus includes an image input unit configured to input image data, a memory, an internal memory unit provided in the image input unit and configured to store the image data input from the image input unit, a transfer unit configured to convert the image data stored in the internal memory unit and to transfer the converted image data to the memory, a deletion unit configured to delete the image data from the internal memory unit, and a notification unit configured to provide notification of an image data deletion result by the deletion unit.

### CROSS-REFERENCE TO RELATED APPLICATIONS

The present application is based on and claims priority to Japanese patent application No. JPAP2004-175801 filed on Jun. 14, 2004 in the Japan Patent Office, the entire contents of which are hereby incorporated reference herein by reference.

### BACKGROUND OF THE INVENTION

1. Field of the Invention

The present invention relates to a method and apparatus for inputting and outputting image data, a computer program for executing the method, and a recording medium for the computer program. More particularly, the present invention relates to an image input and output apparatus having an image processing function for executing image processing on input image data. The present invention further relates to a method executed by the image input and output apparatus, a computer program for executing the image input and output method, and a recording medium on which the computer program executed by the computer is stored in an executable manner.

2. Description of the Background Art

In an image forming apparatus including an image input and output apparatus, image data is converted and processed based on a user's request. In the image forming apparatus connected with a facsimile machine or a network, besides a scanner and a printer, a variety of data conversion techniques are used depending on types of the output image data. Furthermore, high speed processing of a requested image input or output is indispensable.

To execute image data conversion with high speed, the image input and output apparatus often includes a buffer memory. The buffer memory executes image data conversion with respect to a respective image input device and image output device, besides a memory area in a memory. That is to say, in a background technique, although a period for storing image data is short, the image data is stored in the buffer memory.

When a capacity of the buffer memory is not large enough, identifying a content of the image data with help of a content of the stored data is almost impossible. However, it may happen that the buffer memory having the capacity approximately equivalent to an amount of one page is required, depending on types of data conversion techniques. As a result, there is a possibility that storing the image data for even a short period leads to image data leakage. This may happen by intentionally reading the image data, even if the image forming apparatus does not have a function to read out the image data stored in the buffer memory. In recent years, a variety of standards associated with information security have been gradually enacted, while on the other hand, a variety of countermeasures have been discussed to prevent the stored image data from being leaked when storing the image data in the buffer memory.

For example, there are several countermeasures as follows. Data encryption or file access restriction is incorporated to protect the stored image data from being leaked when further connecting the memory with another memory such as a hard disc. There is provided a function of deleting not only file allocation data but also an image data area itself, upon deleting the data. A mechanism in which the memory is detachably installed with ease by the user is also employed.

According to reasons described above, for example, a technique describes a disc storage device provided with an efficient and effective security function in which a disc drive itself has a function of deleting data.

To protect the image data to be processed at a device for inputting a document image in the image forming apparatus from being leaked, for example, the data needs to be deleted, according to need, upon processing the data in the buffer memory for the data conversion or data processing, so that higher security can be achieved. However, when deleting the data in a manner described above, since the image data is automatically deleted in the image forming apparatus, the image data obtained by image input and output processing may become different from image data that the user intends. If the user intentionally acquires the image data by using unlawful means, there is no need to inform the user of a matter that an obtained result is abnormal. On the contrary, when the user intends to use the image forming apparatus in a standard manner, if the obtained result is different from a result, which the user intends, the result being different from the user's intention must be informed to the user.

### SUMMARY OF THE INVENTION

The present invention has been made in view of the above-mentioned and other problems and addresses the above-discussed and other disadvantages. One object of the present invention is to provide a novel method and apparatus for inputting and outputting image data capable of informing the user of the result, so that security and reliability can be improved without disrupting the user, when means for protecting against leakage of the image data to be processed by an image input and output device is provided.

In one aspect, to achieve the above objectives, the present invention advantageously provides a novel image input and output apparatus. In one example, the novel image input and output apparatus includes an image input unit, a memory, an internal memory unit, a transfer unit, a deletion unit, and a notification unit. The image input unit is configured to input image data. The first internal memory unit provided in the image input unit is configured to store the image data input from the image input unit. The transfer unit is configured to convert the image data stored in the internal memory unit and to transfer the converted image data to the memory. The deletion unit is configured to delete the image data. In addition, a notification unit is configured to provide notification of an image data deletion result by the deletion unit.

In another aspect, to achieve the above objectives, the present invention advantageously provides a novel image input and output apparatus including an image input unit configured to input image data, a memory, an image output unit, a first internal memory unit, an image processing unit, a deletion unit, and a notification unit. The image input unit is configured to input image data. The first internal memory unit provided in the image output unit is configured to store the image data input from external to the image output unit. The image processing unit is configured to perform predetermined processing on the image data stored in the first internal memory unit and to output the processed image data. The deletion unit is configured to delete the image data from the first internal memory. In addition, a notification unit is configured to provide notification of an image data deletion result by the deletion unit.

The novel image input and output apparatus according to the invention, may further include a selection unit. The selection unit is configured to select one of two deletion procedures that cause the deletion unit to delete the image data before and after reading out the image data.

The novel image input and output apparatus according to the invention may further include a characteristic identification unit. The characteristic identification unit is configured to identify a characteristic of the image data after storing the characteristic of the image.

The novel image input and output apparatus according to the invention may further include a second memory unit. The notification unit notifies the second memory unit of the image data deletion result by the deletion unit.

The novel image input and output apparatus according to the invention may further include an operation unit. The notification unit notifies the operation unit of the image data deletion result by the deletion unit.

In the novel image input and output apparatus according to the invention, the notification by the notification unit can be performed on a terminal connected with the image input and output apparatus.

In the novel image input and output apparatus according to the invention, the notification by the notification unit can be performed by using electronic mail.

The novel image input and output apparatus according to the invention may further include a choosing unit configured to choose a destination to be notified of the image data deletion result.

In another aspect, to achieve the above objectives, the present invention advantageously provides a novel image input and output method. The method includes storing input image data including a property of an image of an input image signal in an internal memory unit and selecting one of first and second procedures. The first procedure further includes deleting the stored image data, providing notification of a deletion result, and reading out the image data. On the other hand, the second procedure further includes reading out the stored image data, deleting the image data, and providing notification of the deletion result.

In the novel image input and output method according to the invention, the input image signal includes an image signal input by an image input unit.

The novel image input and output method according to the invention may further include performing conversion of the image after completing one of the first and the second procedures.

In the novel image input and output method according to the invention, the input image signal includes an image signal read by the image input unit and stored in the memory.

The novel image input and output method according to the invention may further include performing one of conversion and modification of the image after completing one of the first and second procedures.

In another aspect, to achieve the above objectives, the present invention advantageously provides a novel computer program including a procedure configured to be executed by a computer for executing each of the image input and output method, that is, the above-described operation.

In another aspect, to achieve the above objectives, the present invention advantageously provides a novel recording medium including a computer program. The computer program is configured to contain the computer program described above which is read by the computer and recorded thereon in an executable manner.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of a digital copier according to embodiments of the present invention;

FIG. 2 is a diagram illustrating a document setting table of FIG. 1 seen from above;

FIG. 3 is a timing chart illustrating output timing of an image synchronization signal output from an IPU in a reading part;

FIG. 4 is a block diagram illustrating a configuration of a memory part;

FIG. 5 is a block diagram illustrating one embodiment of an image forming apparatus including functions of respective devices such as a printer, a copier, a facsimile machine, and a scanner in a single housing;

FIG. 6 is a diagram illustrating a hardware configuration of the composite machine according to embodiments of the invention;

FIG. 7 is a diagram illustrating a relation among a local memory, an application specific integrated circuit (ASIC), and an engine of FIG. 6 according to an embodiment of the invention;

FIG. 8 is a flowchart illustrating a processing procedure when executing deletion of an image data stored in a DRAM in the scanner according to an embodiment of the invention, before or after reading out the image data;

FIG. 9 is a diagram illustrating a configuration for image data deletion notification according to an embodiment of the invention;

FIG. 10 is a diagram illustrating, in detail, a relation among a local memory, an ASIC, and an engine in FIG. 6 according to another embodiment of the invention;

FIG. 11 is a flowchart illustrating a processing procedure when executing deletion of image data stored in a DRAM in a plotter according to another embodiment of the invention before or after reading out the image data;

FIG. 12 is a diagram illustrating a configuration for image data deletion notification in another embodiment of the invention;

FIG. 13 is a diagram illustrating a configuration for storing image data deletion information in an EPROM according to yet another embodiment of the invention;

FIG. 14 is a diagram illustrating a system configuration of an image forming apparatus in which notification of an image data deletion result executed in an engine part is performed by using electronic mail according to another embodiment of the invention;

FIG. 15 is a flowchart illustrating a processing procedure for providing notification of the image data deletion result by using the electronic mail according to an embodiment of the invention; and

FIGS. 16A and 16B are flowcharts illustrating a processing procedure in which the image data deletion result is selectively notified.

### DETAILED DESCRIPTION OF THE PREFERRED EMBODIMENTS

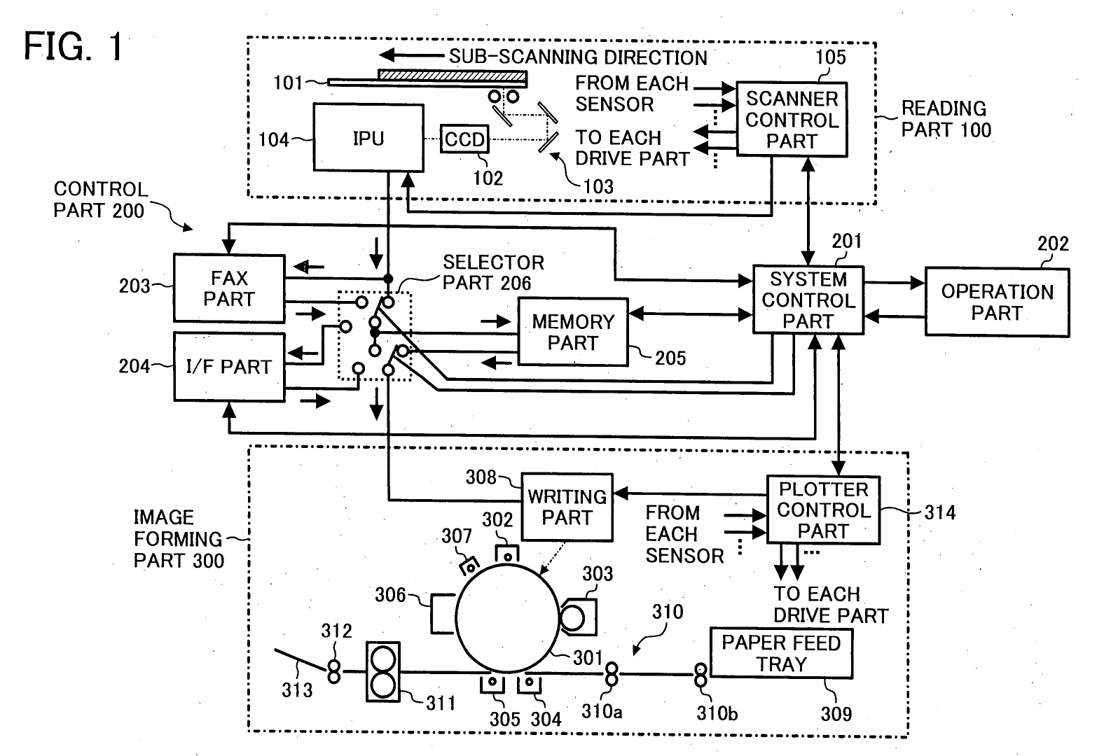

In describing preferred embodiments illustrated in the drawings, specific terminology is employed for the sake of clarity. However, this patent specification is not intended to be limited to the specific terminology so selected and it is to be understood that each specific element includes all technical equivalents that operate in a similar manner. Referring now to the drawings, wherein like reference numerals designated identical or corresponding parts throughout the several views, particularly to FIG. 1, a digital copier according to an embodiment of the present invention will be explained.

It is important to note that, in embodiments hereinafter described, an image input unit corresponds to a reading part 100 or a scanner 120-2, that is, an input. A memory corresponds to a memory part 250 or a local memory (MEM-C) 67. An image output unit corresponds to an image forming part 300 or a plotter 120-3, that is, an output. A first internal memory unit corresponds to a dynamic random access memory 120-1 (DRAM 120-1) and a second internal memory unit corresponds to a dynamic random access memory 120-4 (DRAM 120-4). When sharing a single internal memory unit as the first internal memory unit and the second memory unit, DRAM 120-4 is used. A third internal memory unit corresponds to an Erasable Programmable Read Only Memory 120-5 (EPROM 120-5). A deletion unit, a characteristic identification unit, and a selection unit correspond to functions within a scanner input 120-2 in an engine part 120. An operation unit corresponds to an operation part 202 or an operation panel 70. A first step corresponds to Steps S101 or S201, a second step corresponds to Steps S102 or S202, a third step corresponds to Steps S103, 104, and S105 or S203, S204 and S205, a fourth step corresponds to Steps S107, S108, and S109 or S206, S207, and S208, a fifth step corresponds to Steps S106, and a sixth step corresponds to Steps S209 and S210.

In addition, in the respective units described above and embodiments which will be described below, a term “image signal” represents an image signal in itself which is input or read, and a term “image data” represents aggregation of the image signals and the aggregation thereof functions as a piece of information.

Hereinafter, embodiments of the present invention will be described with reference to the drawings.

In the embodiment, as an example, an image data output device is used as a digital copier.

In FIG. 1, basically, the digital copier includes a reading part 100, a control part 200, and an image forming part 300. The reading part 100 further includes a document setting table 101 made up of a contact glass, an optical reading system 103 provided at an under surface of the document setting table 101 and having a function of irradiating illumination light onto a document and guiding the light reflected from the document to a CCD sensor 102 (image sensor) by using, e.g., a first mirror through a third mirror, an image processing unit 104 (IPU) for converting data optically read by the CCD sensor 102 into digital data capable of being used in a subsequent-stage, and a scanner control part 105 for controlling each part described above.

In a reading procedure for the reading part 100 of the thus configured digital copier, scan-exposure is performed by using an exposure lamp in the optical reading system 103 capable of moving the document in a sub-scanning direction along the document setting table 101, and photoelectric conversion of the reflected light from the document is performed by using the CCD sensor 102 to produce electrical signals in response to a level of the reflected light. The IPU 104 processes the electrical signals to perform shading correction or the like to execute Analog-Digital conversion, so that the electrical signals are converted into 8-bit digital signals. Next, after image processing such as variable power processing and dither processing, an image signal is sent to the image forming part 300 together with an image synchronization signal.

The scanner control part 105 executes detection of respective sensors, control over a drive motor or the like, and setting a variety of parameters for the IPU 104 so that the scanner control part 105 performs the processes described above. All of the processes described above are included in a reading process.

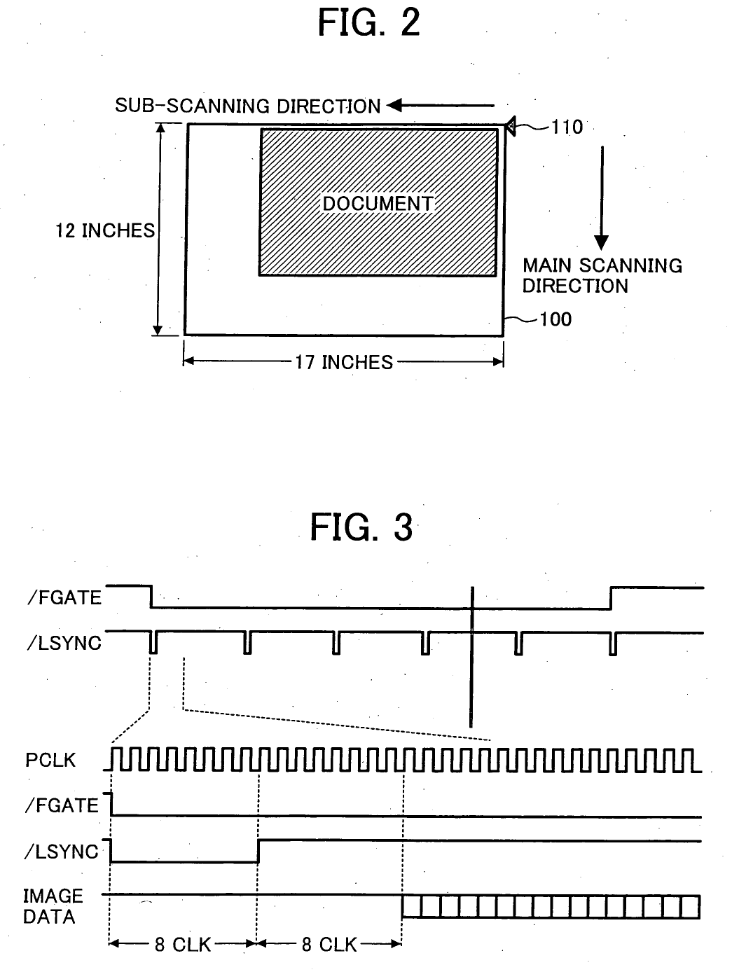

FIG. 2 illustrates the document setting table 101 on which the document to be scanned is set. Here, an arrow portion 110 in FIG. 2 indicates a beginning of the image data to be sent. A horizontal arrow facing left indicates a sub-scanning direction; on the other hand, a vertical arrow facing below indicates a main-scanning direction by the scan-exposure. A dimension of the document setting table in FIG. 2 is, e.g., about 12 inches in height and 17 inches in width.

The control part 200 includes a system control part 201 for controlling the entire digital copier, an operation part 202 functioning as a user interface for the system control part 201, a facsimile part 203 for executing a facsimile transmission to/from an external facsimile machine, an interface part 204 (I/F) for controlling an input and an output from and to external devices, a memory part 205 for storing received information, information to be sent, and image data to be transmitted to the image forming part 300, and a selector part 206 for switching signal transmission and signal reception between the reading part 100, the facsimile part 203, or the interface part 204 (I/F) and the memory part 205.

The system control part 201 detects an input state set on the operation part 202 by an operator to perform setting of the variety of parameters and process execution instructions for the reading part 100, the memory part 205, the image forming part 300, and the facsimile part 203. The operation part 202 accepts inputs from the operator. In addition, the operation part displays a state of an entire system on a display. The instructions for the system control part 201 are performed by the operator through the inputs to the operation part 202 by an operator's key entry.

The facsimile part 203 performs binary compression of the transmitted image data based on a data transfer protocol such as G3/G4 Fax to transfer to a telephone line. In addition, data transferred from the telephone line to the facsimile part 203 is decompressed to produce binary image data, and the binary image data is further sent to the writing part 308 of the image forming part 300. At the writing part 308, the received image data is modulated, so that the image data is written, in an optical manner, on the photoconductive drum 301 to be visualized through the image forming process. As described above, the interface part 204 (I/F) serves as an interface used for controlling inputs and outputs transmitted from and to external devices such as personal computers as a terminal.

The memory part 205 is typically used for applications required for copying such as repeat copying, rotation copying, or the like by storing the image data of the document input from the IPU 104. The memory part 205 is also used as a buffer memory in which the binary image data from the facsimile part 203 is temporarily stored. The system control part 201 gives instructions for storing the data.

The selector part 206 changes a state of a selector based on an instruction from the system control part 201 to select an image data source for performing image formation from any of the reading part 100, the memory part 205, and the facsimile part 203.

The image forming part 300 includes a photoconductive drum 301 on a surface of which a photoconductive layer is formed, a charging charger 302 arranged along an outer circumference of the photoconductive drum 301, a developing device 303, a transfer charger 304, a separation charger 305, a cleaning device 306, a discharging charger 307, and a writing part 308 for performing optical writing on the photoconductive drum 301 to form a latent image on the surface of the photoconductive drum 301, a paper feed tray 309 for feeding a sheet-shaped transfer material as a transfer medium (hereinafter, paper) between the photoconductive drum 301 and the transfer charger 304, and between the photoconductive drum 301 and the separation charger 305, a pair of registration rollers 310A, a pair of paper feeding rollers 310b, a paper feeding device 310 having a conveyance roller (not illustrated), a fixing device 311 for fixing a toner image transferred onto the paper, a pair of paper discharge rollers 312 for ejecting the paper on which the image is fixed, and a paper discharge tray 313 for receiving the paper ejected by the paper discharge rollers 312 so that the paper can be loaded. Each part of the image forming part 300 is controlled by a plotter control part 314.

In an image forming process executed by the image forming part 300, the photoconductive drum 301 is uniformly charged by using the charging charger 302 and rotates with constant speed to be exposed by using laser light modulated by the image data from the writing part 308. The latent images are formed on the photoconductive layer on a surface of the photoconductive drum 301, and the latent images thereon are developed with toner by the developing device 303 to produce visualized toner images. A sheet of paper fed and conveyed from the paper feed tray 309, with help of a mechanism of the paper feeding device having a conveyance roller (not illustrated), by using the feeding rollers 310b is further conveyed in exact timing with the photoconductive drum 301, so that a toner image is electrostatically transferred onto the paper on the photoconductive drum 301 by using the transfer charger 304, and the paper is separated from the photoconductive drum 301 by using the separation charger 305. Thereafter, the toner image on the paper is fixed with heat by the fixing device 311 and the paper is ejected onto the discharge tray 313 by using the discharge rollers 312. On the other hand, a residual toner image remaining on the photoconductive drum 301 after electrostatic transfer processing is removed by the cleaning device 306 pressed against the photoconductive drum 301 and the photoconductive drum 301 is electrostatically discharged by a discharging charger 307. The plotter control part 314 detects outputs from a variety of sensors and controls drive motors or the like to perform the processes described above. All of the processes described above are included in an image forming process.

Referring now to FIG. 3, output timings for the image synchronizations signal are illustrated. In FIG. 3, a frame gate signal (/FGATE) is a signal representing an image effective range with respect to an image area in the sub-scanning direction, and the image data becomes effective while the frame gate signal is at a low level, that is, low active. The frame gate signal is asserted or negated at a falling edge of a line synchronization signal (/LSYNC). The line synchronization signal is asserted by a predetermined number of clocks at a rising edge of a pixel synchronization signal (PCLK), and after the rising edge of the pixel synchronization signal, the image data in a main-scanning direction becomes effective after a predetermined number of clocks. As for the image data that is transmitted, one image data corresponds to one cycle of the pixel synchronization signal, and the image data is substantially divided, on a 400 dpi to 400 dpi basis, from a position indicated by the arrow 110, as described in FIG. 2. The image data is sent as a data with a raster format, and the beginning of the image data is the arrow portion 110. An effective range in the sub-scanning direction of the image data is typically determined depending on the size of the sheet of paper to be transferred. It should be noted that the predetermined number of clocks described here, for example, is 8CLK as illustrated in FIG. 3.

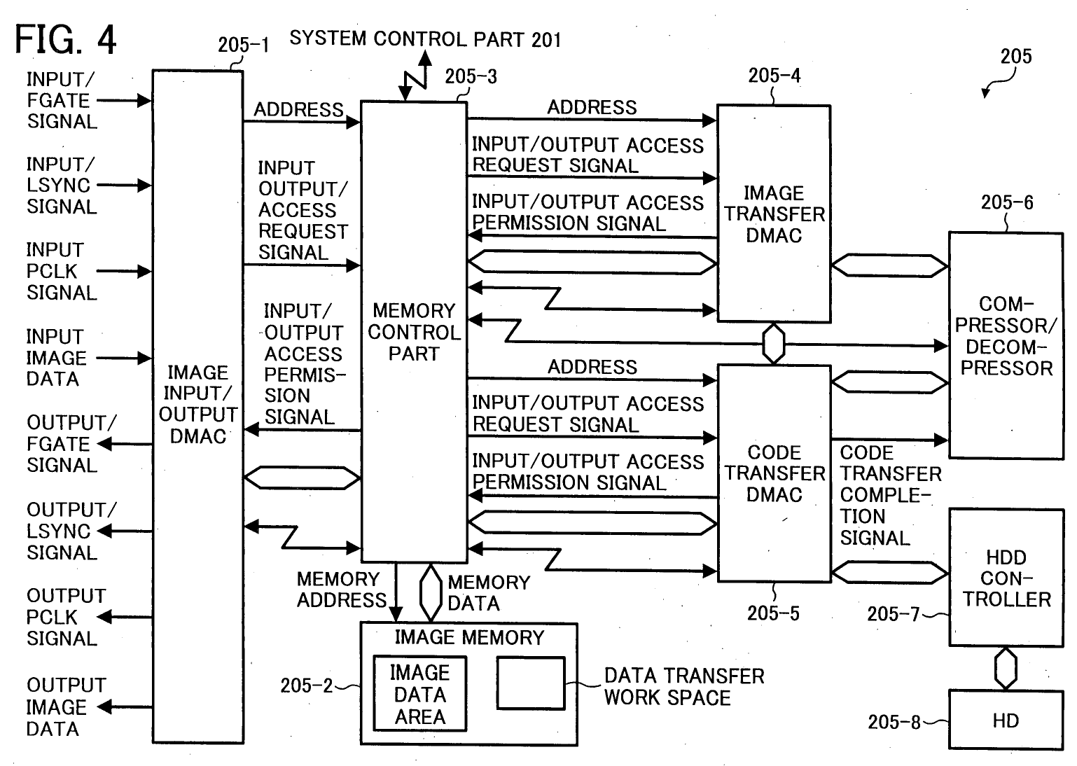

Referring now to FIG. 4, FIG. 4 illustrates the memory part 205. In FIG. 4, the memory part 205 includes a document input and output direct memory access controller 205-1 (DMAC 205-1), an image memory 205-2, a memory control part 205-3, an image transfer direct memory access controller 205-4 (DMAC 205-4), a code transfer direct memory access controller 205-5 (DMAC 205-5), a compressor-decompressor 205-6, an HDD controller 205 7, and a hard disc device 205-8 (HD 205-8). Hereinafter, a detailed description will be given with respect to each block.

(1) Image Input and Output DMAC 205-1

The image input and output DMAC 205-1 includes a CPU and logic and receives commands based on a transmission to and from the memory control part 205-3 so that operation settings in response to the commands are set, while status information is sent to inform of a state of the image input and output DMAC 205-1. Upon receiving the command for image input, the image input and output DMAC 205-1 packs the input image data as memory data in units of 8 pixels based on an input pixel synchronization signal to output together with a memory access signal such as an input and output access request signal to the memory control part 205-3, as needed. The image input and output DMAC 205-1 sends an address to the memory control part 205-3 and receives the input and output access permission signal from the memory control part 205-3. Upon receiving the command, for image output, the image input and output DMAC 205-1 outputs the image data from the memory control part 205-3 while synchronizing the image data, as an output image data, with an output pixel synchronization signal. In addition, an input /FGATE and an input /LSYN are input to the image input and output DMAC 205-1, and an output /FGATE and an output /LSYN are output from the image input and output DMAC 205-1.

(2) Image Memory 205-2

The image memory 205-2 is a primary storage to store the image data. The image memory 205-2 is made up of a semiconductor memory element such as a DRAM, or the like. The image memory 205-2 for example has a total amount of memory capacity with 400 dpi and holds a total of 9 MB including a binary image data of A3 size with 4 MB, a memory for storing electronic sort with 4 MB, and a memory for storing data after data conversion with 1 MB. Readout and writing is controlled by the memory control part 205-3. The image memory includes an image data area and a data transfer work area and receives memory data and a memory address from the memory control part 205-3. Tasks described above are performed by the both areas.

(3) Memory Control Part 205-3

The memory control part 205-3 is made up of a CPU and logic. The memory control part 205-3 receives commands based on a transmission to and from the system control part 201 so that operation settings in response to the commands are set, while status information is sent to inform of a state of the memory part 205. Operation commands from the system control part 201 include commands for image input, image output, compression and decompression, or the like. The commands for the image input and the image output are sent to the image input and output DMAC 205-1, while on the other hand, commands associated with the compression are sent to the image transfer DMAC 205-4, the code transfer DMAC 205-5, and the compressor-decompressor 205-6. The memory control part 205-3 sends the addresses, and the input and output access request signals to the image transfer DMAC 205-4 and the code transfer DMAC 205-5, and receives the input and output access permission signals from the image transfer DMAC 205-4 and the code transfer DMAC 205-5.

Based on an image input instruction from the system control part 201, the memory control part 205-3 is initialized to enter a wait state for the image data, and the image data is input to the memory part 205 based on an operation of a scanner, that is, the reading part 100. The input image data is temporarily written in the image memory 205-2.

In addition, a number of processed lines of the written image data is calculated at the image input and output DMAC 205-1 and input to the memory control part 205-3. Although the compressor-decompressor 205-6 outputs a transfer memory access request signal upon receiving a command for transferring the image data, since a request mask part of the memory control part 205-3 masks the request signal, an actual memory access is not performed. Completion of a single line of input data from the image input and output part unmasks the transfer memory access request signal, so that readout from the image memory 205-2 is executed to start a transfer operation of the image data to the compressor-decompressor 205-6. A difference between the numbers of two processed lines at a difference calculation part is calculated during the operation, and the transfer memory access request signal is masked so as not to overtake an address when zero is obtained.

(4) Image Transfer DMAC 205-4

The image transfer DMAC 205-4 is made up of a CPU and logic and receives commands based on a transmission to and from the memory control part 205-3 so that an operation setting in response to the command is set, and status information is sent to inform of a state thereof.

Upon receiving the command for compression, the image transfer DMAC 205-4 outputs the memory access request signal to the memory control part 205-3 and receives the image data, when a memory access permission signal is activated, to transfer to the compressor-decompressor 205-6.

The image transfer DMAC 205-4 is provided with an address counter therein for counting in response to a memory access request signal to output a 22-bit memory address indicating a storage location on which the image data is stored.

(5) Code Transfer DMAC 205-5

The code transfer DMAC 205-5 is made up of a CPU and logic to receive commands based on a transmission to and from the memory control part 205-3 so that operation settings in response to the commands are set, and status information is sent to inform of a state thereof. Upon receiving the command for decompression, the code transfer DMAC 205-5 outputs the memory access request signal to the memory control part 205-3 and receives the image data, when the memory access permission signal is activated, to transfer to the compressor-decompressor 205-6. In addition, the code transfer DMAC 205-5 is provided with an address counter for counting in response to the memory access request signal to output the 22-bit memory address indicating the storage location on which the image data is stored. When completing the transfer, the code transfer DMAC 205-5 sends a code transfer completion signal to the compressor-decompressor 205-6. A descriptor access operation of the DMAC will be described below.

(6) Compressor-Decompressor 205-6

The compressor-decompressor 205-6 is made up of a CPU and logic and receives commands based on a transmission to/from the memory control part 205-3 so that operation settings in response to the commands are set, and status information is sent to inform of a state thereof. The compressor-decompressor 205-6 processes binary data by, e.g., using an MH encoding technique.

(7) HDD Controller 205-7

The HDD controller 205-7 is made up of a CPU and logic and receives commands based on a transmission to/from the memory control part 205-3 so that operation settings in response to the commands are set, and status information is sent to inform of a state thereof. The HDD controller 205-7 executes status reading and data transfer of the hard disc device 205-8.

(8) HD 205-8

The HD 205-8 is a secondary storage and is a hard disc.

As for an entire operation of the memory part 205, upon inputting the image and storing the data, the image data is written on or read out on a predetermined image area of the image memory 205-2, by using the image transfer DMAC 205-4, based on an instruction from the system control part 201. The image transfer DMAC 205-4 counts a number of image lines during the above operation.

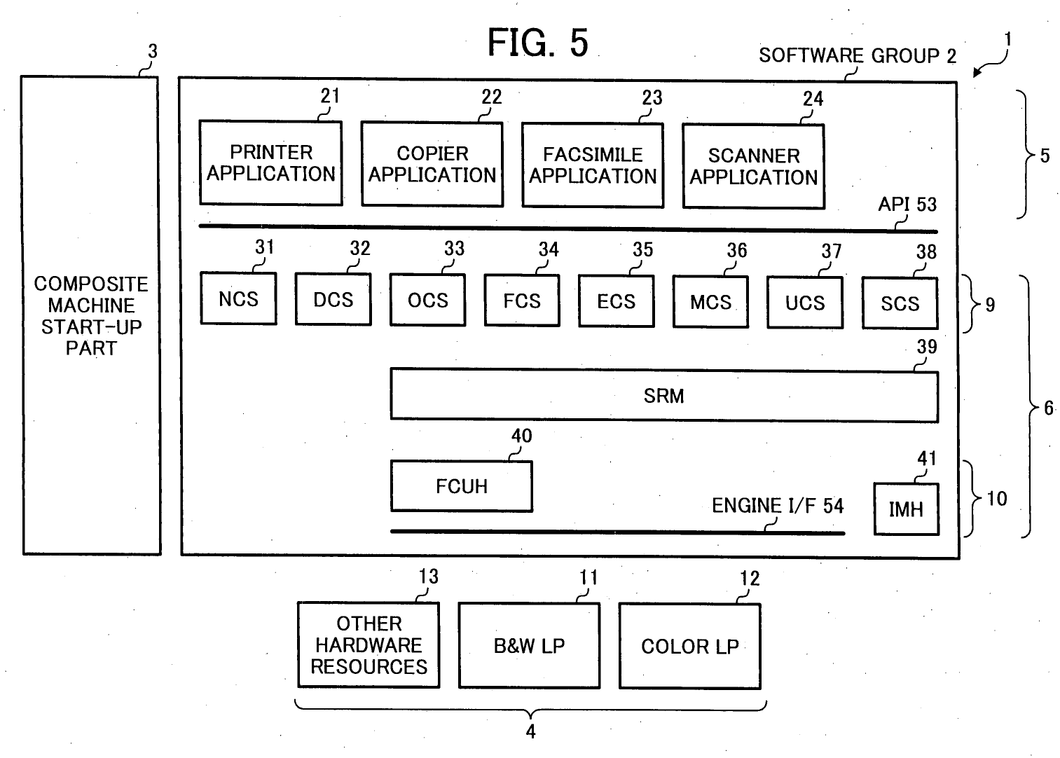

Referring now to FIG. 5, the image forming apparatus includes functions of apparatuses such as a printer, a copier, a facsimile machine, a scanner, or the like, such as the composite machine, in a single housing. The composite machine 1 is configured to include a software group 2, a composite machine start-up part 3, and a hardware resource 4.

The software group 2 includes the application layer 5 and the platform 6 each of which is operated on an operation system, that is, an OS, such as the UNIX (Registered Trademark). The application layer 5 includes programs for executing processing specific to respective user services associated with image formation performed by the printer, the copier, the facsimile machine, and the scanner, respectively.

The composite machine start-up part 3 starts up when supplying power to the composite machine 1 to start up the application layer 5 and the platform 6. For example, the composite machine start-up part 3 reads programs of the application layer 5 and the platform 6 from the hard disc device, or the like, corresponding to an external memory unit and transfers the respective programs thus read out so as to start up. The hardware resource 4 includes a black and while laser printer 11 (B and W LP), a color laser printer 12 (Color LP), and other hardware resources 13 such as the scanner and the facsimile machine.

The application layer 5 includes a printer application 21 which is an application program for use in the printer, a copy application 22 which an application program for use in the copier, a facsimile application 22 which is an application program for use in the facsimile machine, and a scanner application 24 which is an application program for use in the scanner. Each application is executed when the user service specific to the certain hardware resource is executed.

It is noted that the composite machine 1 can process, in an integrated manner, necessary processing required in common for respective application programs, by using the platform 6.

The platform 6 includes a control service layer 9 which interprets a processing request from the application layer 5 to generate an acquisition request for the hardware resource 4, a system resource manager 39 (SRM) which controls at least one hardware resource 4 to adjust the acquisition requests from the control service layer 9, and a handler layer 10 which controls the hardware resource 4 in response to the acquisition request from the SRM 39.

The platform 6 is configured to include an application program interface 53 (API) capable of receiving the processing request from the application layer 5 by using a predetermined function. The OS is capable of executing respective software programs included in the application layer 5 and the platform 6, in parallel, as processes.

The control service layer 9 is configured to includes at least one service module such as a network control service module 31 (NCS), a delivery control service module 32 (DCS), an operation panel control service module 33 (OCS), a facsimile control service module 34 (FCS), an engine control service module 35 (ECS), a memory control service module 36 (MCS), a user information control service module 37 (UCS), a system control service module 38 (SCS), or the like.

A process of the NCS 31 provides services used, in common, by the application programs which require a network input and output, and the process plays a role of an intermediary for distributing data received from the network, via each protocol, to each application program and for transmitting data from each application program to the network. For example, the NCS 31 controls data communications by using network devices connected through the network using a HyperText Transfer Protocol (HTTP) with the help of a HyperText Transfer Protocol Daemon (httpd).

A process for the DCS 32 controls distribution of stored documents, or the like. The process for the OCS 33 controls an operation panel which serves for transmitting information between the operator and main body control. FCS 34 provides Application Interface Programs (APIs) for performing the facsimile transmission such as sending and receiving of the facsimiles using a PSTN network or an ISDN network from the application layer 5, registration and citation of various facsimile data managed by using a backup memory, and reading and printing of received facsimile data.

A process of the ECS 35 controls an engine control part such as a monochrome laser printer 11, a color laser printer 12, other hardware resources 13, or the like. A process of the MCS 36 executes memory control such as acquisition and release of a memory, use of the HDD, or the like. A process of the UCS 37 manages user information. A process of the SCS 38 executes processing such as application management, control of the operation part, system screen display, LED display, hardware resource management, interrupt application control, or the like. A process for SRM 39 performs, along with the SCS 38, system control and hardware resource 4. For example, the process of the SRM 39 plays a role of an intermediary based on the acquisition requests from upper layers using the hardware resource 4 such as the monochrome laser printer 11 or the color laser printer 12 to perform the control.

Specifically, the process of the SRM 39 determines whether or not the requested hardware resource 4 is available, or whether or not the resource is already being used by another acquisition request, and when the requested hardware resource 4 is available, the SRM 39 notifies the upper layers that the requested hardware resource 4 is available. Furthermore, the process of the SRM 39, upon receiving the requests from the upper layers, performs scheduling for using the hardware resource 4, and directly executes requested contents, such as paper feeding and image forming operation, memory acquisition, file generation, or the like by a printer engine.

The handler layer 10 includes a facsimile control unit handler 40 (FCUH), an image memory handler 41 (IMH), and an engine interface 54. The FCUH 40 is used for controlling a facsimile control unit 80 (FCU), which will be described below. The IMH 41 is used for allocating the memory for respective processes and controlling the memory allocated to the processes. Based on a predetermined function, the engine interface 54 transmits the processing requests for the hardware resource 4. The SRM 39 and the FCHU 40 execute processing requests for the hardware resource 4, by using the engine interface 54.

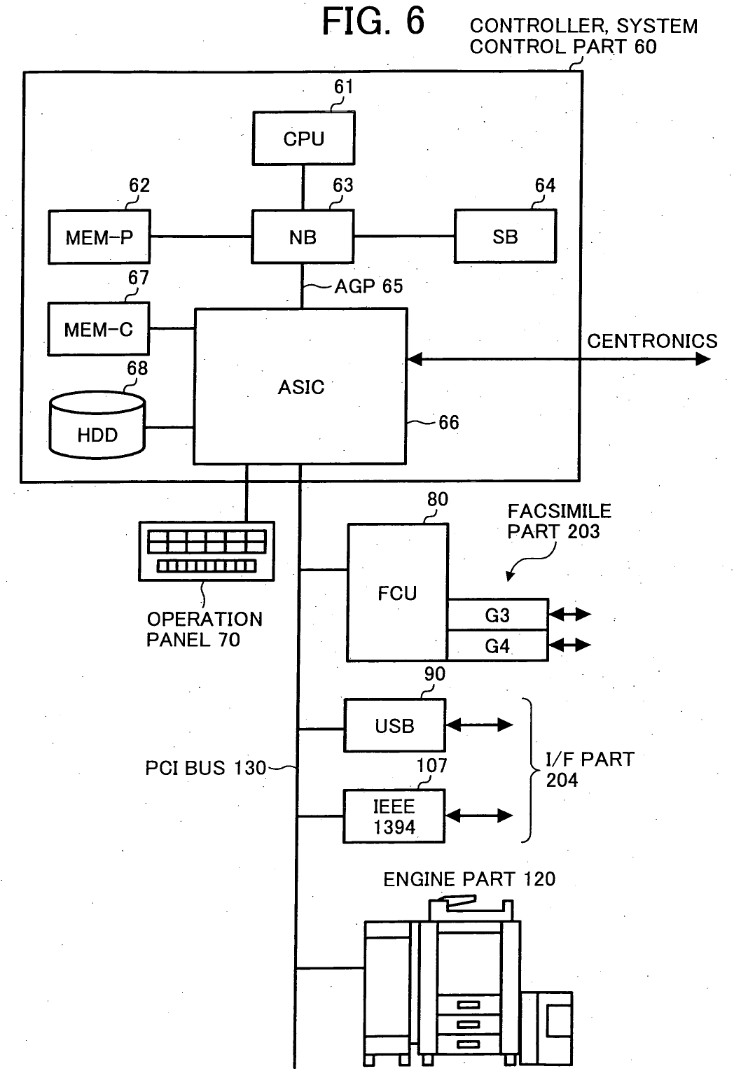

Referring now to FIG. 6, the composite machine 1 includes a controller 60, an operation panel 70, the FCU 80, a USB device 90, an IEEE1384 device 107, and an engine part 120. The G3 and the G4 described above indicate the data transfer protocol on which the transmitted image data is processed.

The controller 60 includes a CPU 61, a system memory 62 (MEM-P), a north bridge 63 (NB), a south bridge 64 (SB), an application specific integrated circuit 66 (ASIC), a local memory 67 (MEM-C), and a hard disc device 68 (HDD). The operation panel 70 is connected with the ASIC 66 of the controller 60. Moreover, the FCU 80, the USB device 90, the IEEE1394 device 107, and the engine part 120 are connected with the ASIC 66 of the controller 60 via a PCI bus 130. In addition, the controller 60 is connected externally via a centronics.

The local memory 67 and the HDD 68 are connected with the ASIC in the controller 60; on the other hand, the ASIC 66 is connected with the CPU 61 via the NB 63 of a CPU chip set. Thus, by connecting the CPU 61 and the ASIC 66 via the NB 63, the controller 60 deals with a case in which an interface of the CPU 61 is not opened to the public. It is important to note that the ASIC 66 and the NB 63 are not connected via the PCI bus but are connected via an Accelerated Graphics Port 65 (AGP). Thus, to control one or more processes that form application layer 5 or the platform 6 in FIG. 5 to execute, degradation in performance can be avoided by connecting the ASIC 66 and the NB 63 not via the low speed PCI bus, but via the AGP 65.

The CPU 61 performs control of the entire composite machine 1. The CPU 61 starts up the NCS 31, the DCS 32, the OCS 33, the FCS 34, the ECS 35, the MCS 36, the UCS 37, the SCS 38, the SRM 39, the FCUH 40, and the IMH 41, as processes, to execute on the OS, respectively, and also starts up the printer application 31, the copy application 32, the facsimile application 33, and the scanner application 34, which form the application layer 5, to execute.

The NB 63 is a bridge for connecting the CPU 61, the MEM-P 62, the SB 64, and the ASIC 66. The MEM-P 62 is a memory used by the composite machine 1 for drawing images, or the like. The SB 64 is a bridge for connecting between the NB 63 and a ROM, the local memory 67, and peripheral devices. Furthermore, the local memory 67 is a memory for the purpose of a code buffer and an image buffer used for copying.

The ASIC 66 is an integrated circuit configured to include hardware elements for the purpose of processing images. The HDD 68 is storage for storing the image data, document data, the programs, and font data along with data having various forms, or the like. The operation panel 70 is an operation part for receiving input operations by the operator, and also for providing displaying for the operator. The FCU 80 device sends and receives the image data to and from the facsimile part 203 via the G3 and G4. The USB device 90 and the IEEE 1394 device communicate with the Interface part 204 that controls the input and output to and from the external devices.

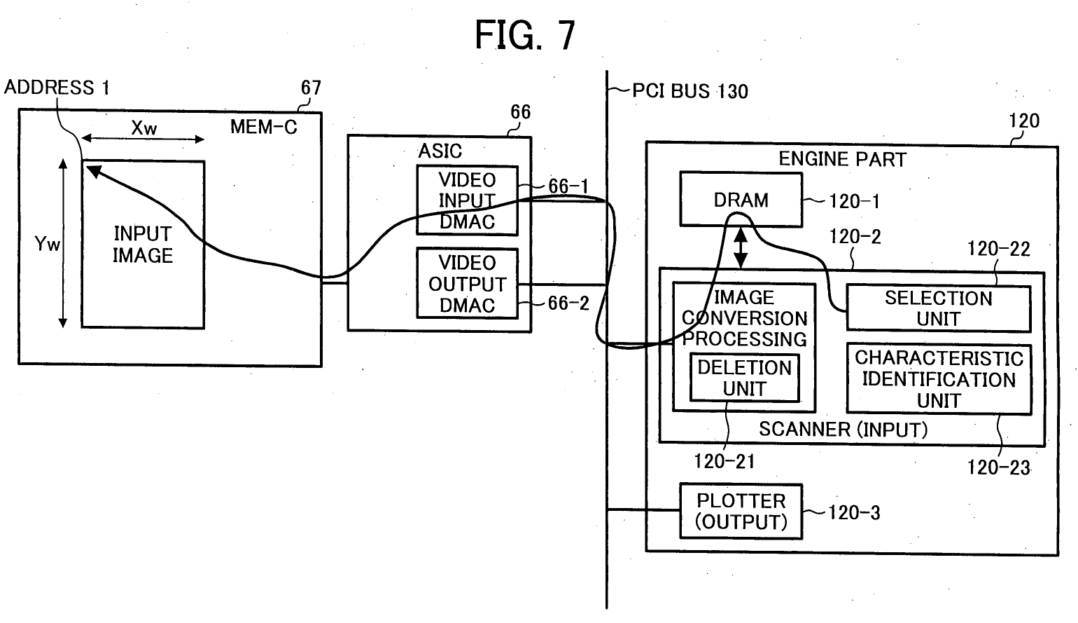

Referring now to FIG. 7, a configuration of a main portion of the composite machine 1 is illustrated. In FIG. 7, the main portion includes a DRAM 120-1 for storing all of or a part of the images input from the reading part 100, in an image input unit (reading part 100), and converting the image data stored in the reading part 100 so as to transfer to the local memory 67 (MEM-C). A curved heavy line having an arrow indicates a flow of the image data.

The engine part 120 includes the scanner 120-2 for image conversion processing and transfer, the DRAM 120-1, and a plotter 120-3. The engine part 120 is connected with a function of the ASIC 66 through the PCI bus 130. The DRAM 120-1 in the engine part 120 stores the image data read by the scanner 100 (reading part) while the image data is subject to the image conversion processing. The ASIC 66 has a function of a direct memory access controller (DMA controller) for transferring the images. The ASIC 66 is also provided with a video input DMA controller 66-1 and a video output DMA controller 66-2.

When transferring the image data read by the reading part 100 to the local memory 67 (MEM-C), IMH 41 reserves a memory space equivalent to a size of the transferred image in the MEM-C 67 in response to a processing request from the SRM 39 to set the size of the transferred image with “Xw times Yw” and a reserved memory address to the video input DMA controller 66-1, so that the image data can be transferred. It should be noted that the scanner 120-2 further includes the deletion unit 120-21, the selection unit 120-22, and the characteristic identification unit 120-23. As for a specific example of deleting, the deletion unit 120-21 writes information data other than scanner input image data onto the DRAM 120-1 by the image conversion processing to update data in the DRAM 120-1. The selection unit 120-22 provides a function for designating a timing to execute deletion processing described above. The selection unit 120-22 selects the timing whether the deletion is to be executed before reading the image data from the DRAM 120-1 or after reading the image data from the DRAM 120-1. The characteristic identification unit 120-23 is a unit for storing the input image data and identifying a characteristic of the image data. As for a specific example of the characteristic identification unit 120-23, the characteristic identification unit 120-23 identifies a characteristic of a document for which copying is prohibited and automatically deletes image data of the relevant document from the DRAM 120-1. The scanner input 120-2 includes the above three units to prevent the data from leaking from an image data memory area within the scanner input 120-2 which serves as a unit for reading the image.

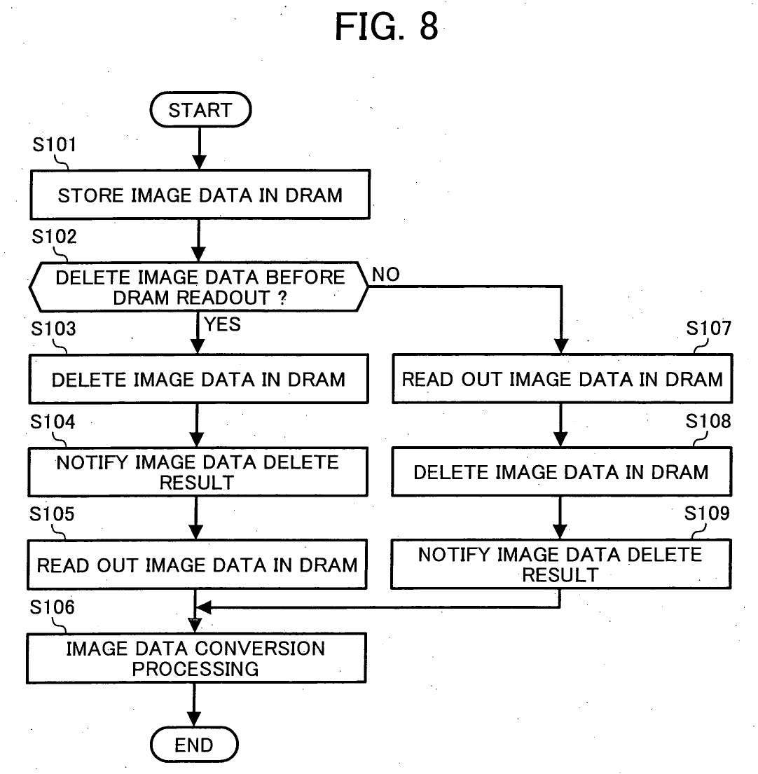

Referring now to FIG. 8, a flowchart illustrates a processing procedure in the composite machine 1 illustrated in FIG. 7 for deleting the image data stored in the memory unit, namely, DRAM 120-1, in the image input unit, namely, the reading part 100, before or after reading out the image data stored in the memory unit in the reading part 100.

In this processing, at first, when converting the image data input from the reading part 100, the DRAM 120-1 stores the image data (Step S101). Next, the ASIC 66 determines whether the image data in the DRAM 120-1 is deleted before reading out the image data from the DRAM 120-1 or not (Step S102).

When deleting the image data in the DRAM 120-1 before readout from the DRAM 120-1 (YES in Step S102), the image data stored in the DRAM 120-1 at step S101 is deleted (Step S103) and the image data in the DRAM 120-1 is read out (Step S105) after notifying the ASIC 66 of an image data deletion result (Step S104). Upon receiving notification, the ASIC 66 displays the result on the operation part 202 (operation panel 70).

When deleting the image data in the DRAM 120-1 after the readout from the DRAM 120-1 (NO in Step S102), the processing procedure proceeds to Step S107 and the image data stored in the DRAM 120-1 at Step S101 is read out (Step S107). Next, the image data in the DRAM 120-1 thus read out is deleted (Step S108) after completing the readout and the image data deletion result is notified to the ASIC 66 (Step S109). When receiving the notification, the ASIC 66 displays the result on the operation part 202, that is, the operation panel 70.

Upon completion of image data deletion in the DRAM 120-1, the notification of the deletion, and the readout (Step S105 or S109), the scanner 120-2 performs the image conversion processing (Step S106).

The notification of the image data deletion in step S104 or step S109 is calculated based on an equation (1) below, and a ratio of an amount of the deleted image data is notified.
Result notification=Amount of deleted data/Amount of total image data (1)

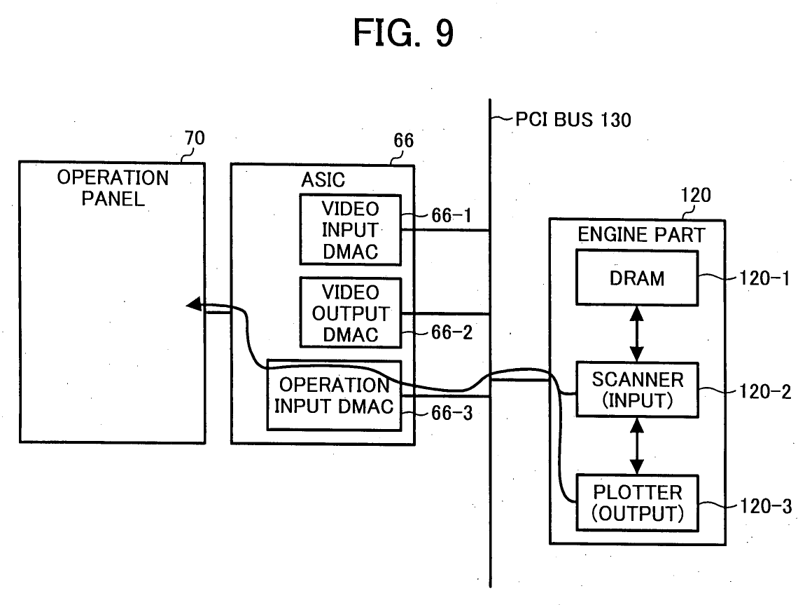

Referring to FIG. 9, the notification is performed on the controller 60, and then the controller 60 displays the notification on the operation panel 70 by using the ASIC 66. A curved heavy line having an arrow indicates the flow of the notification.

A function of the ASIC 66 includes a DMAC function for transferring the image and a DMAC function for transferring an image deletion result. In addition, ASIC 66 is further provided with an operation input DMA controller 66-3 in addition to the video input DMA controller 66-1 and the video output DMA controller 66-2. When transferring the image deletion result to the operation panel 70, the image deletion result is transferred to the ASIC 66 at step S104 or step S109 after image deletion processing is executed, so that the image data deletion result can be acquired by the ASIC 66 to set a value, which causes the image deletion result to be displayed on the operation panel 70, to the operation input DMA controller 66-3. As a result, the image deletion result can be transferred to the operation panel 70.

With the configuration described above, a user can confirm the image deletion result by using the operation panel 70 when executing the image deletion processing.

Thus, in response to purposes whether image data transfer is required or not, unnecessary image processing data can be avoided from being stored by deleting the image data before the image data in the DRAM 120-1 is read out. In addition, the data in the memory can be protected from being leaked by deleting the data in the DRAM 120-1 before the conversion processing. Moreover, the user can confirm the image data deletion result with the notification of the image data deletion.

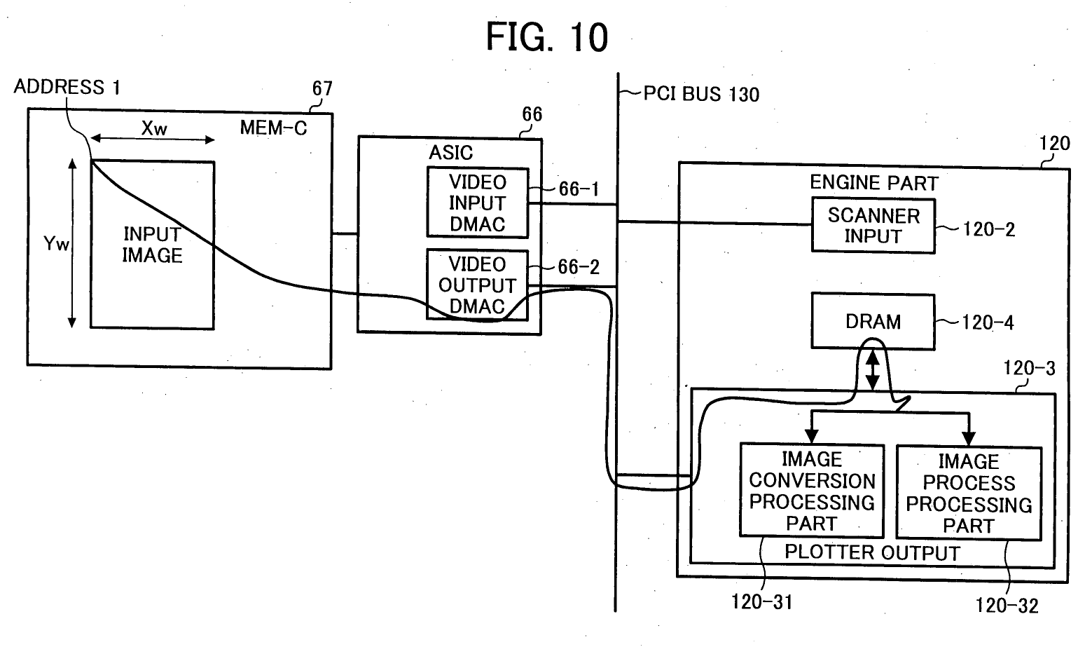

Referring to FIG. 10, a configuration of a main portion of a composite machine 1 according to another embodiment is illustrated. Each part without particular explanation being given has the same configuration as the embodiment as illustrated in FIG. 1 through FIG. 6 and has the same function. Accordingly, the same reference numerals are attached on the same members so that a redundant description is avoided for simplicity.

FIG. 10 illustrates a memory unit, namely the DRAM 120-4, configured to store all of or a part of an image input from external of a reading part 100 into an image input unit, that is, the reading part 100, and the main portion of a composite machine 1 for converting or processing to output image data stored in the image output unit, in other words, the image forming part 300. A curved heavy line having an arrow indicates a flow of the image data.

In FIG. 10, an engine part 120 includes a plotter 120-3, that is the image forming part 300, a DRAM 120-4, and a scanner 120-2, that is the reading part 100, each of which is connected with a function of an ASIC 66 via a PCI bus 130. In addition, the plotter 120-3 further includes an image conversion processing part 120-31 and an image process processing part 120-32.

A function of the ASIC 66 includes a DMAC function for transferring the images. The ASIC 66 further includes a video input DMA controller 66-1 and a video output DMA controller 66-2.

In the composite machine 1, thus configured, when transferring the image read by the scanner 120-2 to a local memory 67 (MEM-C), an IMH 41 reserves a memory space equivalent to a transferred image size in the MEM-C 67 in response to a processing request from a system resource manager 39 (SRM) to set the transferred image size with Xw times Yw, and a memory address of the reserved memory to the video input DMA controller 66-1, so that the image data can be transferred.

When transferring an image signal stored in the MEM-C 67 to the plotter 120-3, that is, an output, the memory address of the transferred image size with Xw times Yw reserved on the MEM-C 67 is set to the video output DMA controller 66-2, so that the image signal can be transferred. The DRAM 120-4 in the engine part 120 stores the image, which is transferred to the plotter 120-3, before image conversion processing or image process processing is executed. The plotter 120-3 converts and processes the image data thus transferred by using the image conversion processing part 120-31 and the image process processing part 120-32.

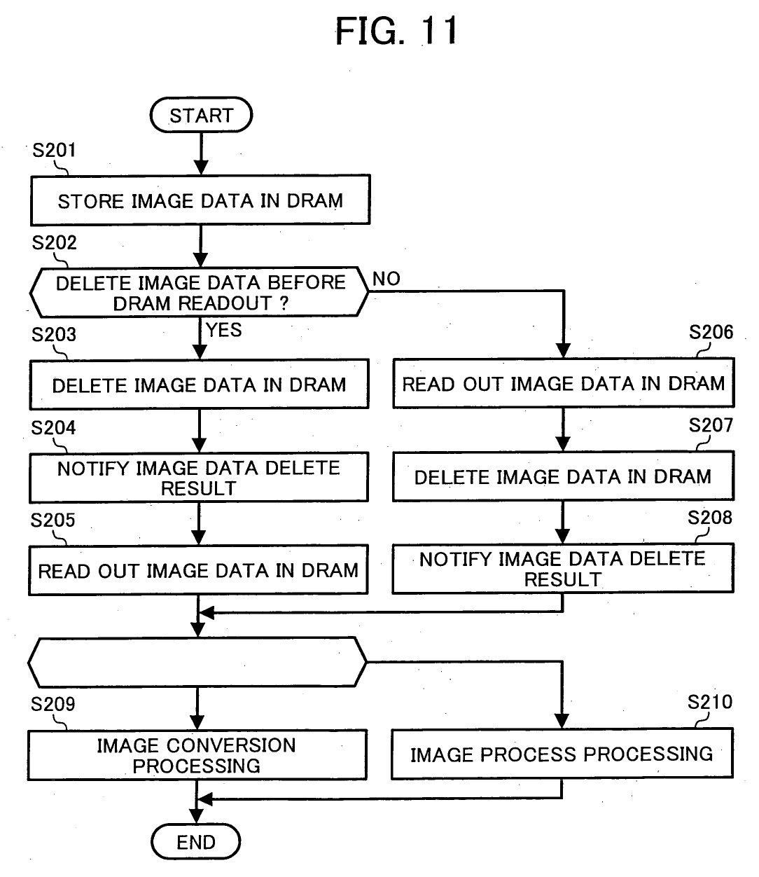

Referring to FIG. 11, a flowchart is described in which the procedure for deleting the image data stored in the memory unit, that is, the DRAM 120-4 in the image output unit, that is, the plotter 120-3, before or after reading out the image data stored in the memory unit, that is, the DRAM 120-4 in the image output unit, in the composite machine thus configured is described.

In this processing, the DRAM 120-4 stores the image data transferred from the MEM-C 67 (step S201). Next, The ASIC determines whether deletion of the stored image data in the DRAM 120-4 at step S201 is executed before readout from the DRAM 120-4 or not (step S202).

When reading out the image data stored at step S201 in the DRAM 120-4 to delete the image data before the readout from the DRAM 120-4 (Step S202-YES), first, the image data in the DRAM 120-4 is deleted (Step S203) and then a modification of an image data deletion result is provided to ASIC 66 (Step S204). Thereafter, the image data in the DRAM 120-4 is read out (Step S205).

When reading out the image data stored at Step S201 in the DRAM 120-4 to delete the image data after the readout from the DRAM 12-4 (NO in Step S202), the image data in the DRAM 120-4 is read out (Step S206). Next, the image data in the DRAM 120-4 is deleted (Step S207) after the readout. Then, the image data deletion result is notified to the ASIC 66 (Step S208). The ASIC 66, upon receiving the notification, displays the result on an operation part 202, that is, the operation panel 70.

Upon completion of image data deletion in the DRAM 120-4 and image data readout from the DRAM 120-4 (Steps S203, S204 and S205, or Steps S206, S207 and S208), the plotter 120-3 performs the image conversion processing (Step S209) and the image process processing (Step S210).

The notification of the image data deletion result is calculated based on an equation (2) below, and a ratio of an amount of the deleted image data is notified to a controller 60.
Result notification=Amount of deleted data/Amount of image data (2)

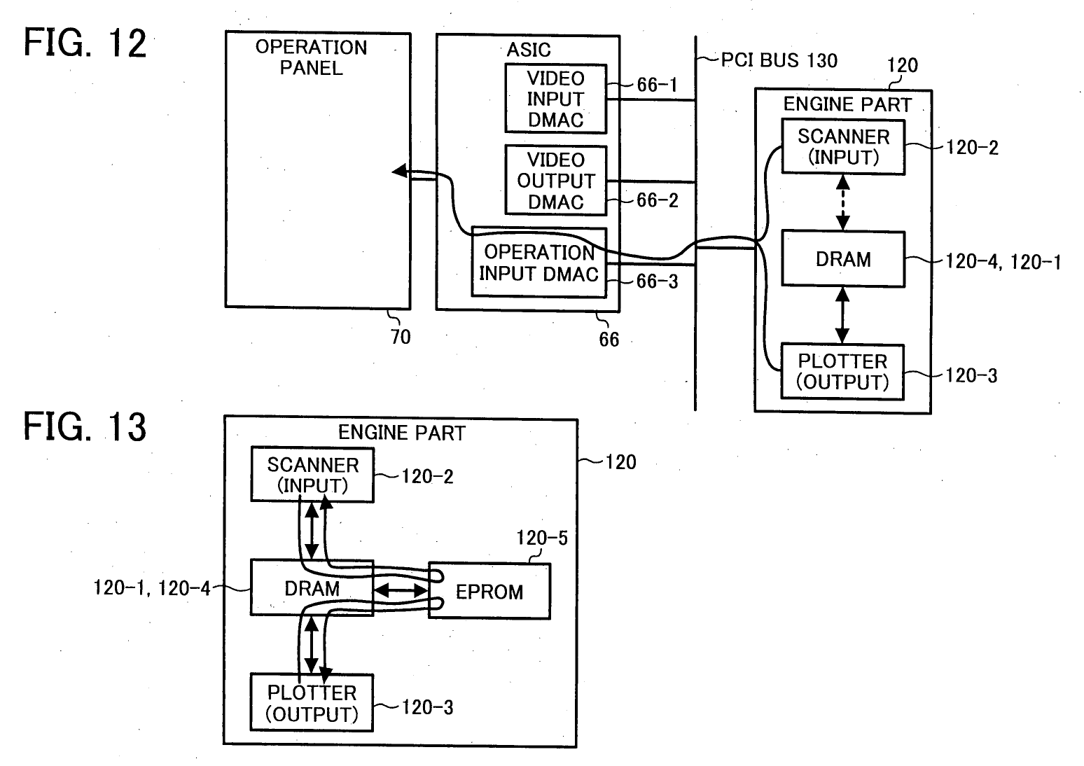

Referring to FIG. 12, FIG. 12 illustrates a configuration of a main portion of a composite machine 1 according to another embodiment. It should be noted that the ASIC 66 includes an operation input DMAC described in the embodiment.

As illustrated in FIG. 12, the notification is performed on the controller 60, and the controller 60 displays the notification on the operation panel 70 through the ASIC 66. A curved heavy line having an arrow indicates a flow of the notification.

The ASIC 66 includes the DMAC function for transferring the image and a DMAC function for transferring the image deletion result. In addition, the ASIC 66 further includes the operation input DMA controller 66-3 in addition to the video input DMA controller 66-1 and the video output DMA controller 66-2. When transferring the image deletion result to the operation panel 70, the image deletion result is transferred to the ASIC 66 at Step S104 or Step S109 after image deletion processing is executed. Then, the ASIC 66 acquires the image deletion result and sets a value by which the image data deletion result is displayed on the operation panel 70, to the operation input DMA controller 66-3. As a result, the image data deletion result can be transferred to the operation panel 70.

With the configuration described above, a user can confirm the image deletion result on the operation panel 70 when executing the image deletion processing.

Accordingly, in response to purposes whether the conversion or the processing of the image data is required or not, unnecessary image processing data can be avoided from being stored by deleting the image data in the DRAM 120-4 before the image data is read out. In addition, the data in the memory can be protected from being leaked by deleting the data in the DRAM 120-4 before the image conversion processing or the image process processing. Moreover, the user can confirm the image data deletion result with the notification of the image data deletion.

It is important to note that sharing the DRAM 120-4 of the embodiment with the DRAM 120-1 in the embodiment allows the DRAM 120-4 to serve as an internal memory unit of the scanner (input) 120-2, as indicated by arrows with a dotted line in FIG. 12.

Referring to FIG. 13, FIG. 13 is a block diagram illustrating a configuration of an engine part 120 according to yet another embodiment.

This embodiment is configured so that an image data deletion result can be stored in the engine part 120. A configuration of each part without a particular description being given is the same as the embodiments illustrated in FIG. 1 through FIG. 12, and the same reference numerals are attached to the same parts so that a redundant description is avoided for simplicity. A curved heavy line having an arrow indicates a flow of notification.

In the embodiment, the engine part 120 includes an EPROM 120-5. The EPROM 120-5 executes image input processing and image output processing. In addition, the EPROM 120-5 stores the image data deletion result after deleting the image data in the DRAM 120-1 or 120-4 and notifying an ASIC 66 of the deletion result. With the configuration including the EPROM 120-5 used for storing the image data deletion result, a person other than an actual user is capable of confirming an image deletion result in a period other than during the image deletion processing.

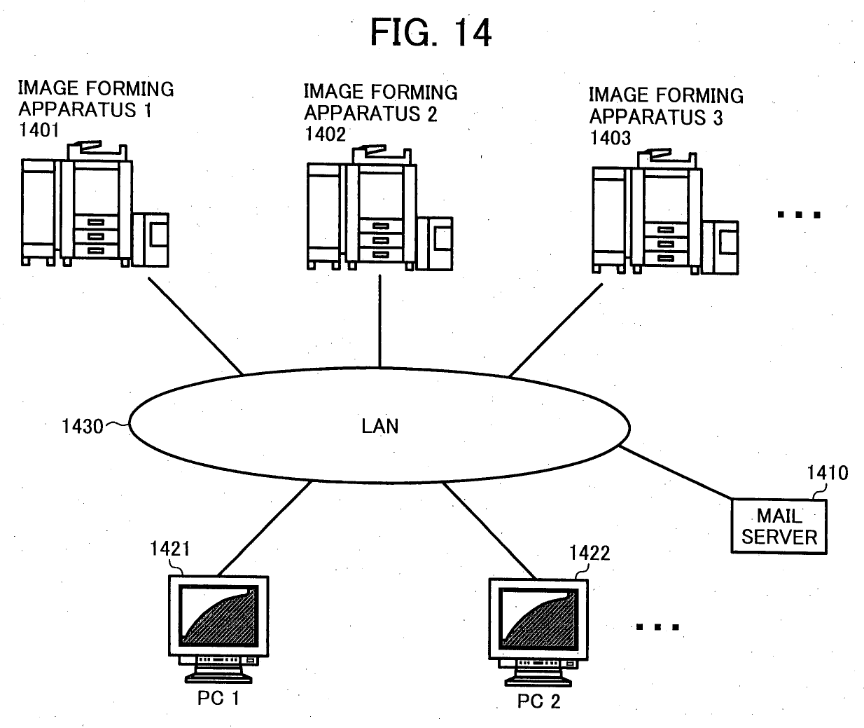

Referring now to FIG. 14, FIG. 14 illustrates a system configuration of an image forming apparatus capable of providing notification of an image data deletion result executed in an engine part 120, that is, an image forming apparatus, by using electronic mail. A configuration of each part without a particular description being given is the same as the embodiments as illustrated in FIG. 1 through FIG. 12, and the same reference numerals are attached to the same parts so that a redundant description is avoided for simplicity.

The system configuration includes the image forming apparatuses 1401, 1402, 1403, a mail server 1410, personal commuters 1421, 1422 (PCs), and a Local Area Network 1430 (LAN), or the like. The image forming apparatus 1401, 1402, and 1403, the mail server 1410, and the PCs 1421, 1422 are connected with one another in a transmittable manner via the LAN 1430. The mail server 1410 is used for managing mail delivery such as receiving and sending of electronic mail. The image forming apparatus 1402, or the like, executes the image data deletion therein, and the PC 1421, or the like, receives the image data deletion result by using the electronic mail. The mail server is a server computer offering a mailing function.

The image forming apparatus 1401, the mail server 1410, and the PC 1421 send and receive electronic mail to one another by using a conventional transmission control protocol such as the Simple Mail Transfer Protocol (SMTP) and the Post Office Protocol (POP). The image forming apparatus on which an image input or an image output is selected is configured so that a mail address input screen for the target PC 1421 receiving notification with the electronic mail can be displayed on an operation panel 70 thereof. A user who intends to input or output an image by using the image forming apparatus enters an electronic mail address of the target PC receiving the electronic mail, on the mail address input screen, and thereafter the user presses a start button used for inputting or outputting the image.

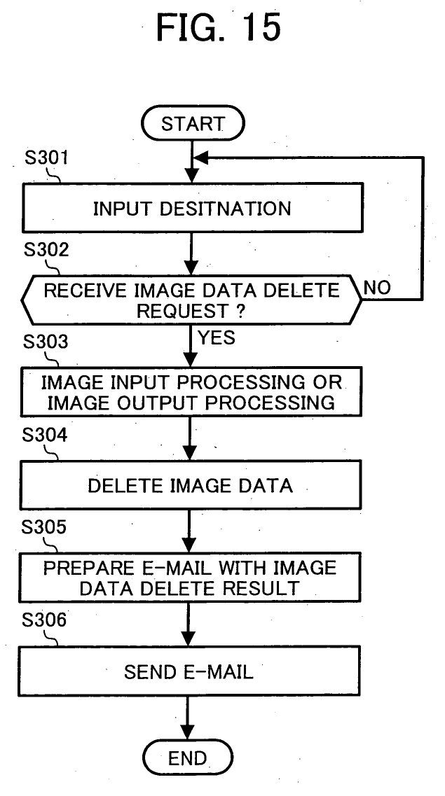

Referring now to FIG. 15, FIG. 15 illustrates a processing procedure providing notification of the image data deletion result by using electronic mail. In the above processing procedure, at first, the electronic mail address input screen for the PC receiving the electronic mail is displayed on the operation panel 70 to receive an entry from the user. When the user presses the start button for inputting or outputting the image, the image forming apparatus determines that an image data deletion request is made (YES in step S302) to start up an image input operation or an image output operation (step S303). When the user does not choose YES in step S302, the processing procedure returns to START. Next, the image forming apparatus executes image data deletion processing (step S304), and generates the electronic mail including the image data deletion result (step S305) to transmit the electronic mail to the PC 1421 (step S306). When transmitting the electronic mail, the procedure defined by the SMTP is employed.

With the configuration described above, checking the electronic mail allows the user to confirm the image data deletion result. Moreover, this configuration allows the user to store the image data deletion result external to the image forming apparatus. Moreover, a troublesome task such as confirmation by the image forming apparatus can be eliminated.

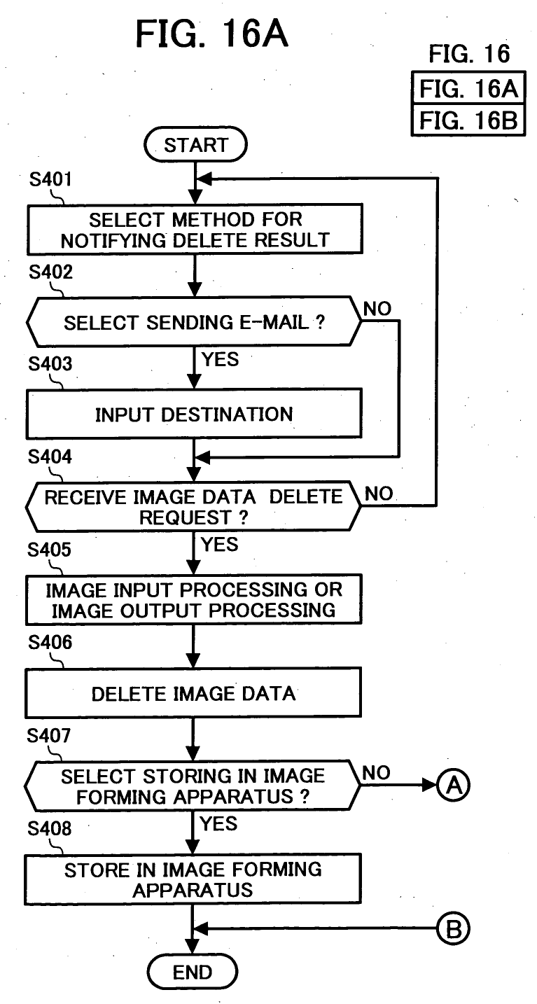

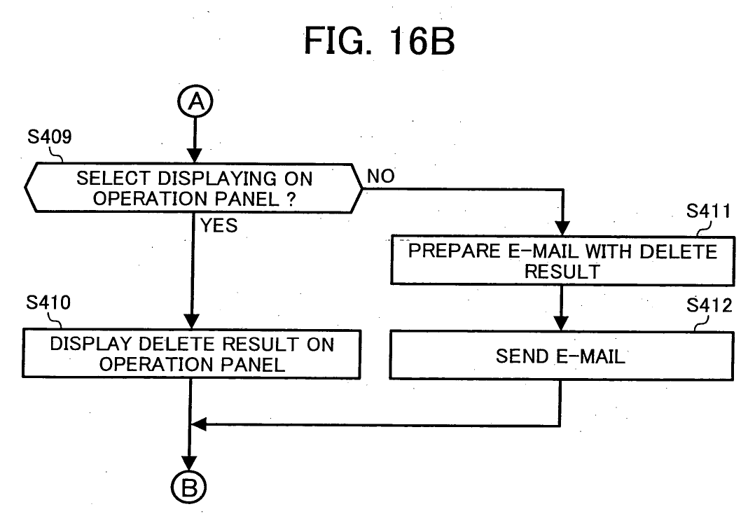

Referring to FIGS. 16A and 16B, FIGS. 16A and 16B illustrate a processing procedure for selectively performing a notification of an image data deletion result. A configuration of each part without a particular description being given is the same as the embodiments as illustrated in FIG. 1 through FIG. 12, and the same reference numerals are attached to the same parts so that a redundant description is avoided for simplicity.

In the processing procedure, a notification method of the image data deletion result is displayed on an operation panel 70 to receive an entry from the user (step S401). When the user chooses to send the electronic mail at step S402 (step S402-YES), a mail address input screen of a PC receiving electronic mail is displayed on the operation panel 70, so that the user can input the electronic mail address (step S403). When the user does not choose YES in Step S402, the processing procedure proceeds to Step S404. When the user press a start button for inputting or outputting the image, the image forming apparatus determines that an image data deletion request is made (step S404) to start up an image input operation or an image output operation (step S405). When the user does not choose YES in Step S404, the processing procedure returns to START.

Thereafter, the image data is deleted (step S406).

On the other hand, when the user chooses to store the image data deletion result within the image forming apparatus in step S407 (step S407-YES), the image data deletion result is stored in an EPROM 120-5 in an engine part 120, that is, an image forming apparatus (step S408, refer to FIG. 13). When the user does not choose YES in Step 407 (NO in Step S407), the processing procedure proceeds to Step S409.

When displaying on the operation panel 70 is chosen in step S409 (step S409-YES), the image data deletion result is displayed on the operation panel 70 (step S410). When the user does not choose YES in Step 409 (NO in Step S409), the processing procedure proceeds to Step S411.

When the user chooses electronic mail transmission in step S401 (step S411), the electronic mail is transmitted to a destination set at step S403 (step S412).

With the procedure described above, the image data deletion result can be utilized in response to purposes of the image data deletion result with respect to each image input processing or image output processing.

As described above, according to the embodiment, when providing the image forming apparatus with a device for protecting the image data processed by a device for inputting and outputting document image in the image forming apparatus from being leaked, the user is free from problems disrupting the user when notifying the user of the image data deletion result. As a result, the image forming apparatus having high security and capable of being used in a safe manner can be provided.

Moreover, in a case in which the user intentionally acquires the image data in an unlawful manner, when the user checks on an abnormal result, there is a possibility that the user tries to avoid a cause of the abnormal result and further enhances unlawful usage. To avoid such a case as described above, an administrator is capable of knowing an advantageous effect of an information leakage prevention function without being detected by the user, by storing the image data deletion result in the EPROM in the engine part 120. As a result, information necessary for managing the image forming apparatus can be obtained.

Furthermore, since the user checks the image data deletion result, when the user who intends to use the image forming apparatus in a normal manner unintentionally deletes the image data, and as a result, when generating unexpected image input and output results different from a result which a user initial intends, the user is capable of checking the cause of an abnormal result to execute prompt measures for obtaining a normal result.

In addition, even in a case in which the image data processing is capable of being executed by remote control from external of the image forming apparatus, a processing result generated by the image forming apparatus can be checked.

Moreover, since a processing result of a target to be checked can be selected, in response to administration purposes of the image forming apparatus, the image forming apparatus is capable of being managed with high flexibility.

The present invention has been described above with reference to specific embodiments. It is important to note that the present invention is not limited to the details of the embodiments described above, but various modifications and improvements are possible without departing from the spirit and scope of the invention.

1. An image input and output apparatus comprising:
an image input unit configured to input image data;
a memory;
an internal memory unit provided in the image input unit and configured to store the image data input from the image input unit;
a transfer unit configured to convert the image data stored in the internal memory unit and to transfer the converted image data to the memory;
a deletion unit configured to delete the image data from the internal memory unit; and
a notification unit configured to provide notification of an image data deletion result by the deletion unit.

2. An image input and output apparatus comprising:
an image input unit configured to input image data;
a memory;
an image output unit configured to output an image signal;
a first internal memory unit provided in the image output unit and configured to store the image data input externally from the image output unit;
an image processing unit configured to perform predetermined processing on the image data stored in the first internal memory unit and to output processed image data;
a deletion unit configured to delete the image data from the first internal memory unit; and
a notification unit configured to provide notification of an image data deletion result by the deletion unit.

3. The image input and output apparatus according to claim 2, further comprising a selection unit configured to select one of two deletion procedures for causing the deletion unit to delete the image data before and after reading out the image data.

4. The image input and output apparatus according to claim 2, further comprising a characteristic identification unit configured to identify a characteristic of the image data after storing the characteristic of the image data.

5. The image input and output apparatus according to claim 2, further comprising a second internal memory unit, and wherein the notification unit notifies the second internal memory unit of the image data deletion result by the deletion unit.

6. The image input and output apparatus according to claim 2, further comprising an operation unit, and wherein the notification unit notifies the operation unit of the image data deletion result by the deletion unit.

7. The image input and output apparatus according to claim 2, wherein the notification by the notification unit is performed on a terminal connected with the image input and output apparatus.

8. The image input and output apparatus according to claim 2, wherein the notification by the notification unit is performed by using electronic mail.

9. The image input and output apparatus according to claim 2, further comprising a choosing unit configured to choose a destination to be notified of the image data deletion result.

10. An image input and output apparatus comprising:
means for inputting image data;
means for storing;
means for internally storing the image data input from the means for inputting, the means for internally storing being provided in the means for inputting;
means for converting the image data stored in the means for internally storing and for transferring the converted image data to the means for storing;
means for deleting the image data from the means for internally storing; and
means for providing notification of an image data deletion result by the means for deleting.

11. An image input and output apparatus comprising:
means for inputting image data;
means for storing;
means for outputting an image signal;
first means for internally storing the image data input from external to the means for outputting, the first means for internally storing being provided in the means for outputting;
means for performing predetermined processing on the image data stored in the first means for internally storing and for outputting the processed image data;
means for deleting the image data from the first means for internally storing; and
means for providing notification of an image data deletion result by the means for deleting.

12. The image input and output apparatus according to claim 11, further comprising means for selecting one of two deletion procedures causing the means for deleting to delete the image data before and after reading out the image data.

13. The image input and output apparatus according to claim 11, further comprising means for identifying a characteristic of the image data after storing the characteristic of the image data.

14. The image input and output apparatus according to claim 11, further comprising second means for internally storing, and wherein the means for notifying notifies the second means for internally storing of the image data deletion result by the means for deleting.

15. The image input and output apparatus according to claim 11, further comprising means for operating, and wherein the means for notifying notifies the means for operating of the image data deletion result by the means for deleting.

16. The image input and output apparatus according to claim 11, wherein the notification by the means for notifying is performed on means for communicating connected with the image input and output apparatus.

17. The image input and output apparatus according to claim 11, wherein the notification by the means for notifying is performed by means for electronically sending and receiving the notification with help of a computer network.

18. The image input and output apparatus according to claim 11, further comprising means for choosing a destination to be notified of the image data deletion result.

19. A method for inputting and outputting image data comprising:
storing input image data including a property of an image in the input image data in an internal memory unit;
selecting one of first and second procedures, the first procedure comprising:
deleting the stored image data from the internal memory unit,
providing notification of a deletion result, and
reading out the image data; and
the second procedure comprising:
reading out the stored image data,
deleting the image data from the internal memory unit, and
providing notification of the deletion result.

20. The image input and output method according to claim 19, wherein the input image data includes an image signal input by an image input unit.

21. The image input and output method according to claim 20, further comprising:
performing conversion of the image data after completing one of the first and second procedures.

22. The image input and output method according to claim 20, wherein the input image data includes an image signal read by the image input unit and stored in the internal memory unit.

23. The image input and output method according to claim 22, further comprising:
performing one of conversion and modification of the image data after completing one of the first and second procedures.

24. A computer program comprising:
a procedure configured to be executed by a computer for executing the image input and output method according to claim 19.

25. A recording medium comprising:
a computer program configured to include the computer program according to claim 24 read by a computer and recorded in an executable manner.
